(19) United States
(12) Patent Application Publication
(10) Pub. No.: US 2007/0136679 A1
(43) Pub. Date: Jun. 14, 2007

(54) Circular multimedia playback progress indicator and method of indicating signals thereof

(76) Inventor: Qi-Ming Yang, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/376,227

(22) Filed: Mar. 16, 2006

(30) Foreign Application Priority Data
Dec. 13, 2005 (TW) 94144116

(51) Int. Cl. H04N 5/44

(52) U.S. Cl. 715/772; 715/716

(57) ABSTRACT

A circular multimedia playback progress indicator displayed on a screen during a multimedia playback and a method of indicating signals thereof is claimed. The circular indicator appears when playing or controlling a multimedia content and comprises a circular display area displayed on a screen during a playback or a control; a status indicating area for displaying a playback status by one or a plurality of status icons; a circular timeline for displaying the playing length of a multimedia content by a circular stripe area; a circular buffer indicating area for dynamically displaying a buffer status of the multimedia content by a circular stripe color area; and a progress index for dynamically displaying the playback progress of the multimedia content. The above-mentioned areas adopt different colors and/or levels of transparency to distinguish the different displaying functions separately.

### BACKGROUND OF THE INVENTION

1. Field of the Invention

The present invention relates to a circular multimedia playback progress indicator and a method of indicating signals thereof, and more particularly to a circular multimedia playback progress indicator displayed on a screen when controlling the playback of a multimedia content.

2. Description of Related Art

In addition to traditional wireless TV and cable TV, the behavior of watching television is increasingly changed to watch the network TV or video on demand (VOD).

A video time-shifting apparatus disclosed in U.S. Pat. No. 5,701,383 is applied to a video recording system having a multiple of write heads, and an audio/video playback progress indication is disclosed in one of the preferred embodiments as shown in FIG. 1. FIG. 1 shows a timeline 10 for displaying the playing time of desired audio/video content for viewing, and the shaded portion (recorded area 12) indicates the state of recording audio/video content to a storage medium, and the blank portion is an unrecorded area 14, and the boundary 13 shows the time of the recording. Users can control and move the arrowhead 11 to any position in the recorded area 12 for viewing the corresponding content.

Furthermore, U.S. Pat. No. 5,903,264 also discloses a playback time used for downloading audio/video data streams, so that users can use the time indicator to switch a viewing position.

The foregoing real-time audio/video download method is used for viewing TV programs, watching movies, and listening to music from a system such as a video on demand (VOD), and users can use the corresponding multimedia player for viewing and listening to the audio/video content. The prior art provides users a friendly playback and control interface that can be used in a simple and easy environment. Referring to FIG. 1 for the multimedia visual progress indication system disclosed in U.S. Pat. No. 6,847,778 and FIG. 2 for the schematic view of the disclosed indication system, a screen 20 (such as a TV screen or a computer screen) shows a rectangular audio/video playback bar 21, wherein a scroll bar 22 for adjusting the playback position is shown in addition to the audio/video beginning and ending time. While an audio/video file is played or downloaded, a memory in the multimedia player can buffer (or record) an audio/video data stream which is displayed in the cache 23 of the playback bar 21 as shown in the figure, so that users can switch to any position of the cache 23 anytime to view the content buffered in the memory.

Other than the aforementioned prior art audio/video playback indication mode, a circular multimedia playback progress indicator of the present invention provides a multimedia playback progress indicator and its signaling method, which has not much space occupation and is easy to use.

### SUMMARY OF THE INVENTION

Therefore, it is an objective of the present invention to provide a circular multimedia playback progress indicator and a method of indicating signals thereof. The claimed invention is easy to understand and control circular playback progress interface during a multimedia playback. The invention is applied to a multimedia product, such as a personal video recorder (PVR), a media center, a digital media server, a digital media player, a portable media player, a game console, a network TV, and a network TV set top box (IPTV STB), etc.

The foregoing circular multimedia playback progress indicator is a circular indicator displayed on a screen when a multimedia content is played and controlled, wherein the circular indicator according to a preferred embodiment comprises a circular display area displayed on the screen during a multimedia playback or control; a status indicating area for displaying a playback status of the multimedia content by one or a plurality of status icons; a circular timeline for displaying a playback length of the multimedia content by a circular stripe area; a circular buffer indicating area for dynamically displaying a buffer status of the multimedia content by a circular stripe color area; a progress index for dynamically displaying a playback progress of the multimedia content, wherein the status icon, the circular stripe area of the circular timeline, the bar shape color area of the circular buffer indicating area, the progress index, and the circular color area of the circular display area are adjacent color areas with different display color types for distinguishing the display function of each area.

The preferred embodiment of the signaling method of a circular multimedia playback progress indicator of the present invention comprises the steps of using a multimedia player for receiving a multimedia content downloaded from network, cable TV, or wireless means and buffering the content into a buffer memory, and then starting the playback of the multimedia content, such that if a user wants to control the operations of play, stop, pause, fast forward, and rewind, the indicator will receive the control signal of the multimedia playback to activate the foregoing circular multimedia playback progress indicator and display it at a specific position on a screen, wherein the circular multimedia playback progress indicator also displays a circular timeline for indicating a playback length of the multimedia content; displaying a playback status of the multimedia content by a status icon; displaying a buffer status of the multimedia content, and its buffer status is dynamically displayed on a circular timeline by a circular stripe color area; displaying a playback progress of the multimedia content, and the playback progress is indicated by a progress index dynamically displayed on the circular timeline; and clearing the display of the circular multimedia playback progress indicator within a period after receiving the control signal.

The flow chart of another signaling method of the circular multimedia playback progress indicator of the preferred embodiment of the invention comprises the steps of displaying a circular multimedia playback progress indicator on a screen during the playback of the multimedia content, and then displaying a buffer status by a circular buffer indicating area of a specific color after a control signal is detected, and displaying a status of recording to the storage medium by a record indicating area of a specific color, and if a pause or stop signal is received, the progress index on the circular timeline of the circular multimedia playback progress indicator will stop; if a fast forward/rewind control signal is received, the progress index moves forward or rewinds quickly, and then processing the steps of buffering and recording the multimedia content.

To make it easier for our examiner to understand the innovative features and technical content, we use a preferred embodiment together with the attached drawings for the detailed description of the invention, but it should be pointed out that the attached drawings are provided for reference and description but not for limiting the present invention.

### BRIEF DESCRIPTION OF THE DRAWINGS

FIG. 1 is a schematic view of a prior art audio/video playback indication;

FIG. 2 is a schematic view of a prior art audio/video playback indication;

FIG. 3 is a schematic view of using a circular multimedia playback progress indicator of the present invention;

FIG. 4 is a schematic view of a circular multimedia playback progress indicator of a preferred embodiment of the present invention;

FIGS. 5A to 5C are schematic views of using a circular multimedia playback progress indicator of the present invention;

FIG. 6 is a schematic view of a circular multimedia playback progress indicator of a preferred embodiment of the present invention;

FIGS. 7A to 7C are schematic views of using a circular multimedia playback progress indicator of the present invention;

FIG. 8 is a flow chart of a method of indicating signals of a circular multimedia playback progress indicator according to a preferred embodiment of the present invention; and

FIG. 9 is a flow chart of a method of indicating signals of a circular multimedia playback progress indicator according to a preferred embodiment of the present invention.

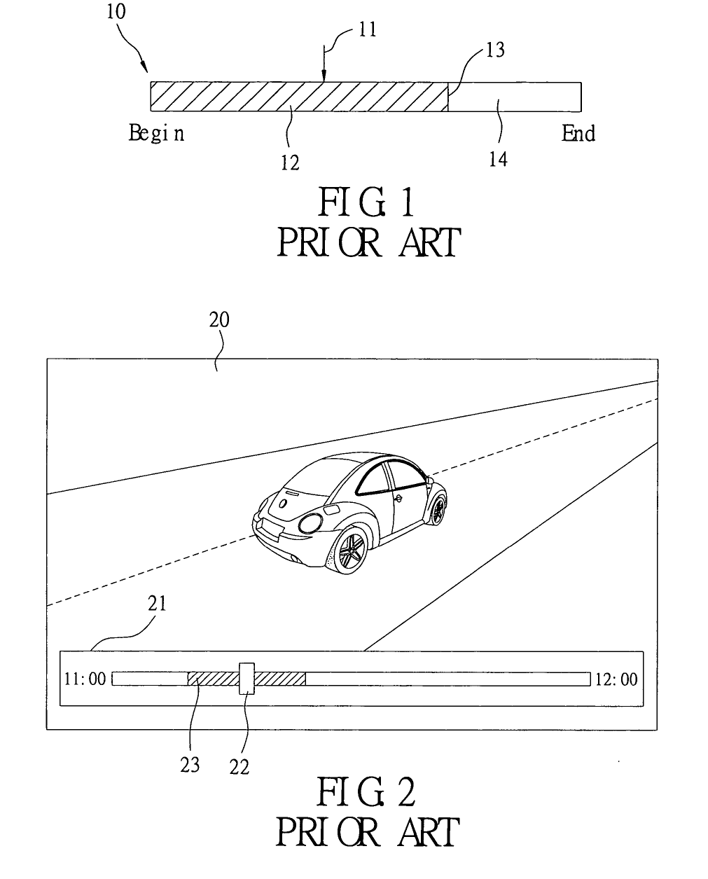

### DETAILED DESCRIPTION OF THE PREFERRED EMBODIMENTS

A circular multimedia playback progress indicator of the invention and a method of indicating signals thereof provide a simple, direct, and easy to understand and control circular playback progress interface on a screen (such as a TV screen or a computer screen, etc.) during the playback of a multimedia content. The invention can be applied to multimedia products including a personal video recorder (PVR), media center, digital media server, digital media player, portable media player, game console, and network TV set top box (IPTV STB), etc. If a user operates the multimedia player by using a remote control or a control interface, the circular multimedia playback progress indicator of the invention will remind the user about the current program length, buffering program length, recording program length, current playback time, and current system playback status (play, stop, pause, fast forward, or rewind, etc) displayed on a screen during the control of an operation.

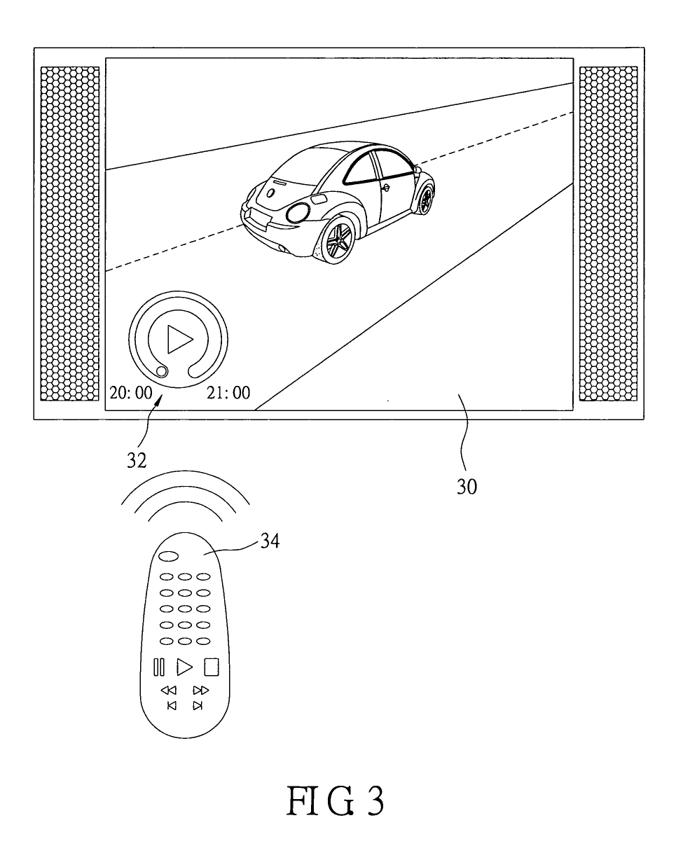

Referring to FIG. 3 for a preferred embodiment of the present invention, the circular multimedia playback progress indicator is displayed on a screen, when a user views or listens to a downloaded streaming of audio/video multimedia contents, and the display is achieved by a transparent, semi-transparent, and opaque means. During the display period, a remote control 34 can be used for performing different functional operations including play, pause, stop, fast forward/rewind play of different multiples (1×, 2×, or 3×), slow play, slow reverse play, and record, etc. The present invention can be applied for viewing or listening to a TV program, network TV and video on demand (VOD) through wireless or cable means. In a control, the circular multimedia playback progress indicator 3 can be displayed at a specific position on a screen 30 by software or firmware, and the specific position can be a factory default setting or a user-defined setting.

The foregoing circular multimedia playback progress indicator displayed on a screen indicates the length of a multimedia content, and the playback position information is displayed on a progress indicating cursor in a circular indicating area, and the playback status information can be displayed by identified characters or symbols accompanied with accurate descriptions of digital information of time. If a portion of the multimedia content is situated at a special status (such as pause or record), then the length and position of such portion will be identified by the different color in the circular indicating area, wherein the message of the progress indicating cursor and status indicating area varies according to the playback status.

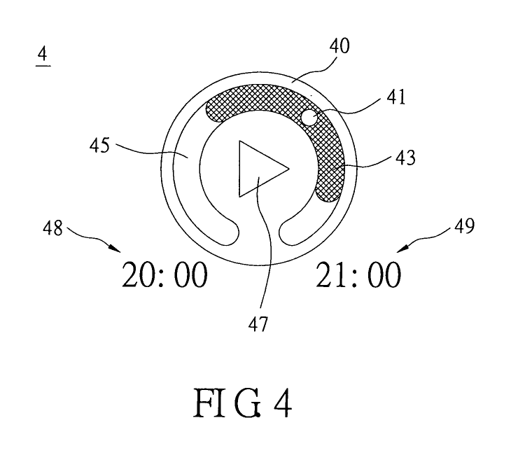

Referring to FIG. 4 for the circular multimedia playback progress indicator of a preferred embodiment of the invention, a circular multimedia playback progress indicator 4 is displayed on a screen during the playback or control of a multimedia content, and the display is in form of a plurality of transparent, semi-transparent, or opaque color areas and comprises the following:

(1) A circular display area 40 is a background of the transparent, semi-transparent, or opaque circular color areas displayed on a screen during a multimedia playback or control.

(2) A status indicating area 47 is displayed in the foregoing circular display area 40, and one or a plurality of status icons can be used for displaying a multimedia content playback status and indicated by an area with a color different from that of the color circular display area 40. In the figure, the playback status icon is represented by a triangle, a fast forward/rewind play by two triangles, a pause status by two rectangular bars, a stop status by a square, and a record status by a circle. However, actual practices are not limited to the aforementioned representation as illustrated in the figure and description.

(3) A circular timeline 45 is displayed in the circular display area 40 for displaying the playback length of a multimedia content by a circular stripe area and indicating the playback time in a clockwise direction or a counterclockwise direction, and this circular stripe area is an area having a color different from that of the circular display area 40.

(4) A time display area 48, 49 for indicating a beginning time and an ending time of the foregoing circular timeline 45 or displaying the time division of storing a multimedia content into a buffer memory or displaying a playback progress of a multimedia content, or displaying a playback time duration of a multimedia content. In the preferred embodiment as shown in the figure, the beginning and ending time of the multimedia content are displayed on both sides of the circular display area 40, but practical implementations are not limited to such arrangement only.

(5) A circular buffer indicating area 43 is displayed on the foregoing circular timeline 45 for dynamically displaying the status of buffering a multimedia content into a buffer memory by a circular stripe color area and using an area with a color different from that of the circular timeline 45 for its representation. When the multimedia content is started downloading, a supply end continuously downloads the multimedia content to a buffer memory to achieve a smooth playback.

(6) A progress index 41 is displayed in the circular buffer indicating area 43 for dynamically displaying the playback progress of the multimedia content and also representing the progress by an area with a color different from that of the circular buffer indicating area 43. Users can play a buffered multimedia content at different timing positions controlled by a cursor or other control methods.

Each of the foregoing color areas is an area adjacent to another area of a different color and display type for distinguishing the display function of each area.

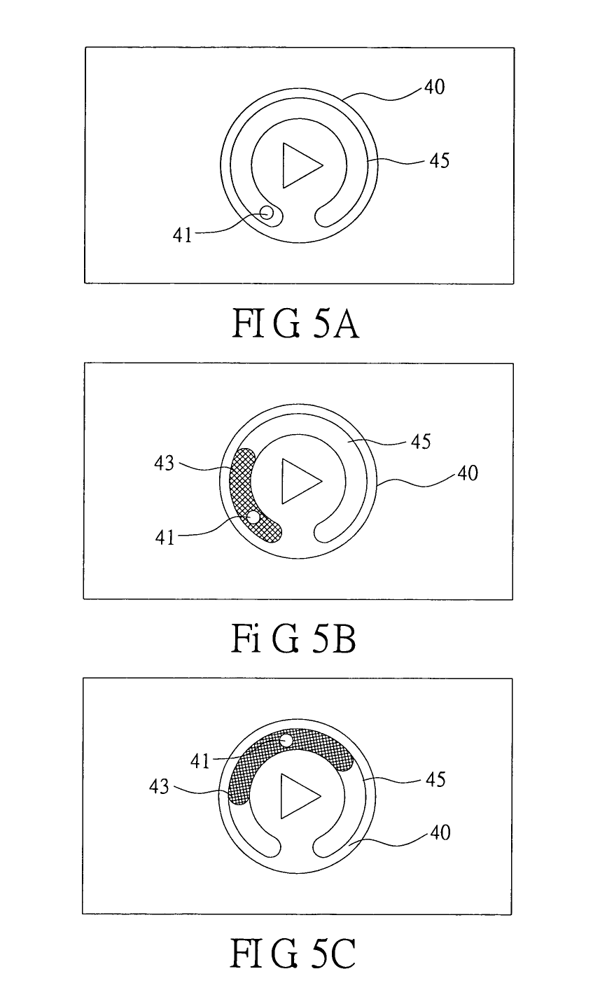

At the beginning of playing a multimedia content, the foregoing circular multimedia playback progress indicator 4 is displayed on a screen as shown in FIG. 5A, when a user executes the play function, wherein the progress index 41 is displayed on a circular timeline 45 in a circular display area 40, and the supply end continuously downloads the streaming data of the multimedia content to the buffer memory.

In FIG. 5B, after the multimedia content has been played for some time, the circular timeline 45 displays a color area having a circular buffer indicating area 43 for showing the length of the multimedia content buffered in the memory, and users can easily switch the content to any position on the circular buffer indicating area 43.

FIG. 5C shows a display state of the multimedia content to another time period.

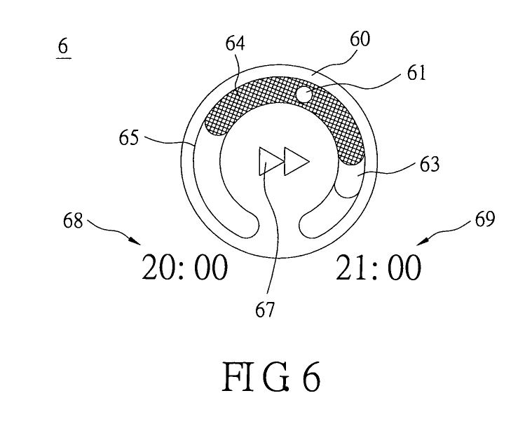

Referring to FIG. 6 for the circular multimedia playback progress indicator according to another preferred embodiment of the present invention, this embodiment is applied to storing a multimedia content into a storage medium such as a hard disk drive, an optical disk drive, a flash memory, or other non-volatile memory, and a circular multimedia playback progress indicator 6 is the same as that disclosed in FIG. 4. Accordingly, the circular multimedia playback progress indicator is formed by a plurality of transparent, semi-transparent, or opaque color areas, and essentially comprising:

(1) A circular display area 60, which is formed by a transparent, a semi-transparent, or an opaque circular color area.

(2) A status indicating area 67, which is provided for displaying the playback status by one or a plurality of status icons in a circular display area 60, wherein the icons are illustrated in FIG. 4.

(3) A circular timeline 65, which is displayed in the circular display area 60 for displaying the playback length of the multimedia content.

(4) A display areas 68, 69, which are provided for displaying the beginning and ending time of the circular timeline 65, and other preferred embodiments can display the time division of storing the multimedia content into a buffer memory, or display the playback progress of the multimedia content, or display the playback time of the multimedia content.

(5) A progress index 61, which is provided for dynamically displaying the playback progress of the multimedia content, and users can control the position of this progress index 61 to play the multimedia content at a different time period.

(6) A record indicating area 64, which is displayed in front of or behind a progress index 61. If the multimedia content is downloaded, the content will be recorded into a storage medium (or transferred from a buffer memory to this storage medium) and this record indicating area 64 displayed in the circular timeline 65 indicates the status of recording the multimedia content.

(7) Besides the display of multimedia content recorded to the record indicating area 64 of the storage medium, the status of buffering the multimedia content into a buffer memory is displayed dynamically in the circular buffer indicating area 63 of the circular timeline 65. In other words, if there is no multimedia content stored in the storage medium, the player will continuously download the multimedia content to the buffer memory, so as to achieve a smooth playback.

The foregoing color areas are the color areas adjacent to each other with a different color, and particularly the progress index 61, the record indicating area 64, and the circular buffer indicating area 63 are displayed in the circular timeline 65 in the areas or icons with different colors and/or levels of transparency for distinguishing the display functions of separate areas.

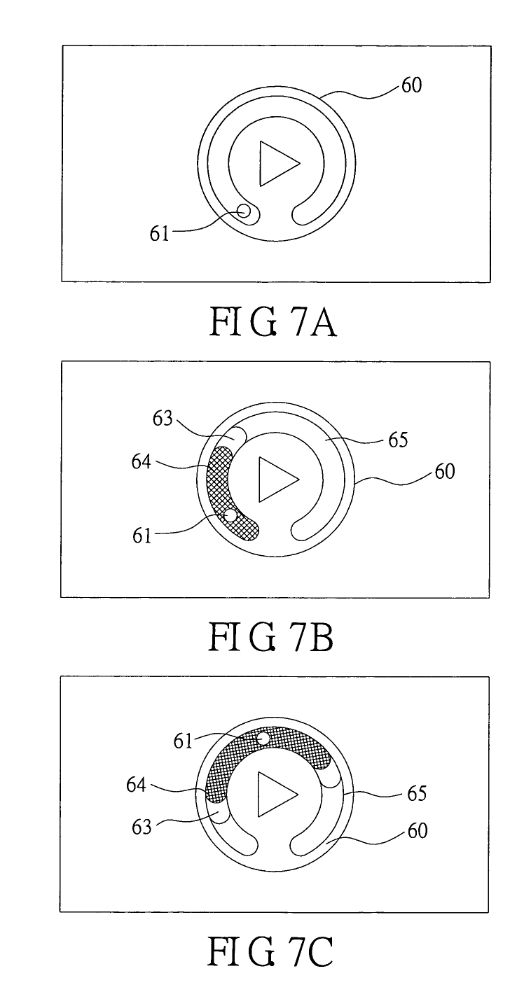

FIGS. 7A to 7C show the display status of a preferred embodiment as illustrated in FIG. 6. At the beginning, a user performs a control as shown in FIG. 7A, the circular display area 60 is displayed on a screen in a transparent, semi-transparent, or opaque form, wherein the progress index 61 is displayed at the beginning of the circular timeline 65.

In FIG. 7B, after a period of playing of the multimedia content, the circular timeline 65 in the circular display area 60 displays the circular buffer indicating area 63, indicating that the multimedia content is buffered into a buffer memory, and showing that the multimedia content is recorded into the record indicating area 64 of the storage medium, and using the progress index 61 to show the current playback progress.

In FIG. 7C, after another period of playing, the situation is the same as described in FIG. 7B. It is worth pointing out that the multimedia content indicated by the record indicating area to be recorded into the storage medium is transferred from the buffer memory. In this exemplary figure, the covered area by the circular buffer indicating area 63 in the circular timeline 65 is larger than the area covered by the record indicating area 64, so as to indicate the playback progress currently.

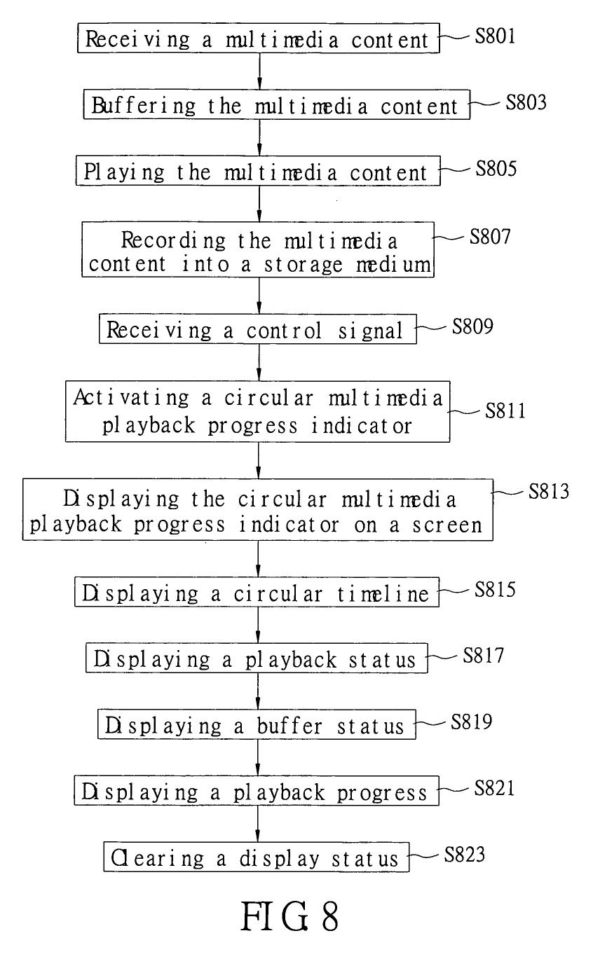

Referring to FIG. 8 for the method of indicating signals for the circular multimedia playback progress indicator of the present invention, the flow chart of the method is described as follows:

At the beginning, different devices are prepared and installed, such as the online status and playback preparation, and then the process starts receiving a multimedia content (Step S801). A player can download a multimedia content, if the process starts playing or has not started playing, and then the multimedia content is stored in a buffer memory, and the buffer memory can be a dynamic random access memory (DRAM), a flash memory, or a hard disk drive (Step S803). If the buffer memory has a stored multimedia content, then the process will start playing according to the user's control (Step S805). If the multimedia content is being played or has not been played, the multimedia content will be recorded to a storage medium (which could be a non-volatile memory) first (Step S807).

If the player receives a control signal from a user's operation or other system responding measures (such as turning the system off or setting the system to a sleep mode) (Step S809), then the circular multimedia playback progress indicator of the invention will be activated (Step S811), and the indicator displaced on the screen will be achieved by fade-in, pop-up, or immediate show (Step S813) for simultaneously or sequentially displaying the circular timeline (Step S815) and displaying the playback status by a status indicating area (Step S817), displaying the buffer status by a circular buffer indicating area (Step S819), displaying the playback progress by a progress index (Step S821), and then clearing the foregoing display status after not receiving a control signal for a period of time or exceeding a predetermined time (Step S823).

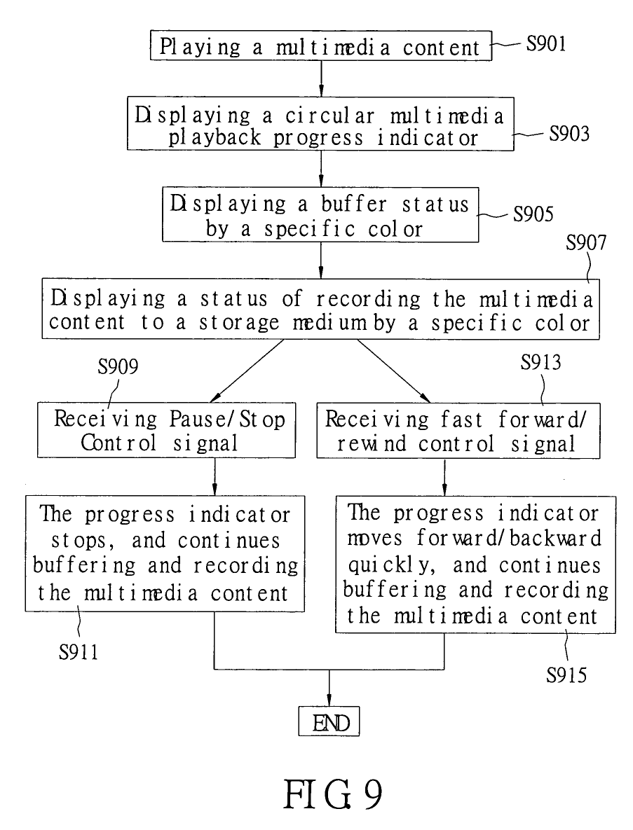

FIG. 9 shows a preferred embodiment of different operating statuses:

The playback of the multimedia content is started (Step S901), and the circular multimedia playback progress indicator is displayed on the screen (Step S903). It is necessary to detect a control signal by a user's operation, which is normally displayed on a screen in some embodiments. When the circular multimedia playback progress indicator is displayed, a specific (predetermined) color will be used to indicate a buffer status (Step S905), and another specific (predetermined) color will be used to indicate a status of recording the multimedia content to a storage medium (Step S907). Upon the operation of a user, a pause signal or a stop signal as described in Step S909 is received, and thus the progress index on the circular timeline will be stopped. However, the buffering and/or recording progress will be processed depending on the memory size including the buffer space and the recording space (Step S911). When the user operates a fast forward/rewind operation as described in Step S913, the progress index will move forward or backward quickly, and the buffering and recording progress will be processed according to the memory size (Step S915).

To sum up, the present invention relates to a circular multimedia playback progress indicator and a signal method, wherein the circular multimedia playback progress indicator is displayed on a screen when a multimedia content is played or controlled. The status icon, the circular stripe area of the circular timeline, the bar color area of the circular buffer indicating area, the progress index, the content record indicating area, and the circular color area of the circular display area are color areas adjacent to each other and having different display types for distinguishing the display function of each area, and each area can be displayed in a wholly or partially transparent, semi-transparent, or opaque form.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A circular multimedia playback progress indicator, displayed on a screen when controlling a playback of a multimedia content, comprising:
a circular display area, being a circular color area displayed on said screen when controlling said playback of said multimedia content;
a status indicating area, displayed in said circular display area for displaying a playback status of said multimedia content by one or a plurality of status icons;
a circular timeline, displayed in said circular display area for displaying a playback length of said multimedia content by a circular stripe area;
a circular buffer indicating area, displayed on said circular timeline for dynamically displaying a buffer status of said multimedia content by a circular stripe color area; and
a progress index, displayed in said circular buffer indicating area for dynamically displaying a playback progress of said multimedia content by said progress index;
wherein said status icon, said circular stripe area of said circular timeline, said stripe color area of said circular buffer indicating area, said progress index, and said circular color area of said circular display area are adjacent color areas with different display color types for distinguishing the displaying function of each area.

2. The circular multimedia playback progress indicator of claim 1, wherein the indicator further comprises at least one time display area.

3. The circular multimedia playback progress indicator of claim 2, wherein said time display area displays a time division for storing said multimedia content into a buffer memory.

4. The circular multimedia playback progress indicator of claim 2, wherein said time display area displays said playback progress of said multimedia content.

5. The circular multimedia playback progress indicator of claim 2, wherein said time display area displays a time duration of playing said multimedia content.

6. The circular multimedia playback progress indicator of claim 1, wherein the indicator further comprises a record indicating area displayed on said circular timeline for indicating a status of recording said multimedia content into a storage medium.

7. The circular multimedia playback progress indicator of claim 1, wherein said status icon displayed in said status indicating area comprises a play icon, a pause icon, a stop icon, a fast forward play icon, and a rewind play icon.

8. The circular multimedia playback progress indicator of claim 1, wherein said circular multimedia playback progress indicator is displayed on a position of said screen with a factory default setting or a user-defined setting.

9. A method of indicating signals for a circular multimedia playback progress indicator, wherein said circular multimedia playback progress indicator is displayed on a screen when controlling a playback of a multimedia content, and said method of indicating signals for said circular multimedia playback progress indicator comprises the steps of:
receiving said multimedia content;
buffering said multimedia content into a buffer memory;
playing said multimedia content;
receiving a control signal;
activating said circular multimedia playback progress indicator;
displaying said circular multimedia playback progress indicator on said screen;
displaying a circular timeline for indicating a playback length of said multimedia content;
displaying a playback status of said multimedia content, and said playback status being displayed in said circular multimedia playback progress indicator by one or a plurality of status icons;
displaying a buffer status of said multimedia content, and said buffer status being dynamically displayed on said circular timeline by a circular stripe color area; and
displaying a playback progress of said multimedia content, and said playback progress being dynamically displayed by a progress index on said circular timeline.

10. The method of indicating signals for a circular multimedia playback progress indicator of claim 9, wherein the display of said circular multimedia playback progress indicator is cleared within a period after receiving said control signal.

11. The method of indicating signals for a circular multimedia playback progress indicator of claim 9, further comprising a step of recording said multimedia content to a storage medium.

12. A method of indicating signals for a circular multimedia playback progress indicator, comprising the steps of:
playing a multimedia content;
displaying a circular multimedia playback progress indicator on a screen;
detecting a control signal;
displaying a buffer status by a circular buffer indicating area with a predetermined color;
displaying a status of recording to a storage medium by a record indicating area with a predetermined color;
stopping a progress index on a circular timeline of said circular multimedia playback progress indicator, if a pause signal or a stop signal is received;
processing a fast forward play or a rewind play for said progress index, if a fast forward or a rewind control signal is received; and
processing a step of buffering and a step of recording.

13. The method of indicating signals for a circular multimedia playback progress indicator of claim 12, wherein said step of buffering is to buffer said multimedia content into a buffer memory.

14. The method of indicating signals for a circular multimedia playback progress indicator of claim 12, wherein said step of recording is to record said multimedia content into a storage medium.
